(19) United States
(12) Patent Application Publication
(10) Pub. No.: US 2009/0142022 A1
(43) Pub. Date: Jun. 4, 2009

(54) MULTI-PORT CONNECTOR HAVING ESATA CONNECTOR AND OPTICAL FIBER TRANSMITTING CONNECTOR

(76) Inventor: Yi-Fang CHUANG, Sanchong City (TW)

Correspondence Address: HDLS Patent & Trademark Services, P.O. BOX 220746, CHANTILLY, VA, 20153-0746, US

(21) Appl. No.: 12/190,030

(22) Filed: Aug. 12, 2008

(30) Foreign Application Priority Data
Nov. 30, 2007 (TW) 096220430

(51) Int. Cl. G02B 6/38

(52) U.S. Cl. 385/75

(57) ABSTRACT

A multi-port connector having eSATA (external serial advanced technology attachment) connector and optical fiber transmitting connector includes a seat body, an eSATA connector, an optical fiber transmitting connector, a sealing lid and an outer casing. A first slot and a second slot are respectively arranged on the seat body. At back of the seat body, there is a recessing part, at upper portion of which an assembling opening communicated to the first slot is arranged. A plurality of slots are arranged on a wall surface of the recessing part. The eSATA connector is assembled in the first slot, while the optical fiber transmitting connector is assembled in the second slot. The sealing lid is assembled to the recessing part. The outer casing externally fitted to the seat body is arranged a first perforation and a second perforation at front side face thereof and respectively corresponding to the first slot and the second slot. A set of assembling legs are extended from a side face at a bottom part of the outer casing. By means of the eSATA connector and the optical fiber transmitting connector, a plugging-in function can be provided to an eSATA transmitting line and an optical fiber patch cord.

### BACKGROUND OF THE INVENTION

1. Field of the Invention

The present invention in general relates to a connector, in particular, to a multi-port connector.

2. Description of Prior Art

Following a continuous progress of technology, there are many computer peripherals are manufactured successively. For example, in order to make computer able to be electrically connected to these peripherals of new generation, there are many connecting ports, with various specifications, arranged on a computer's motherboard, so that the computer can be electrically connected to the peripherals through various transmitting lines, making the computer able to output control signal or transmit data to the peripherals, or receive data transmitted back from the peripherals, vice versa.

Please refer to FIG. 1. In recent years, the size of computer has a trend of miniaturization, so the volume of a computer's motherboard 100 is shrunk as well. Under the conditions of a shrunk volume and a limited space of motherboard 100, in order to arrange a plurality of connecting ports with various specifications, for example, a printer's connecting port 200 can be directly screwed at a supporting body 300, by which the connecting port 200 is overlapped to another or other connectors 200a, 200b, or it is possible to add slots to the connectors with same specification, for example, a USB connector 400 or a PS/2 connector 500, both of which have multi-slots, as shown in FIG. 1.

Currently, if it is needed to arrange an eSATA (external serial advanced technology attachment) connector and an optical fiber transmitting connector on a motherboard 100, as shown in FIG. 1, it has to sacrifice a connecter or use the supporting body 300 to overlap the eSATA connector and the optical fiber transmitting connector over another or other connectors 200a, 200b due to the limited space in the motherboard 100. This way of arranging the eSATA connector and the optical fiber transmitting connector onto the motherboard 100 causes a lot of inconveniences to the motherboard 100 in terms of the manufacturing procedure.

Accordingly, aiming to solve aforementioned shortcomings, after a substantially devoted study, in cooperation with the application of relatively academic principles, the inventor has finally proposed the present invention that is designed reasonably to possess the capability to improve the prior arts significantly.

### SUMMARY OF THE INVENTION

The invention is mainly to integrate an eSATA connector and an optical fiber transmitting connector into a multi-port connector, such that the multi-port connector can be electrically connected to a motherboard.

The invention is to provide a multi-port connector having eSATA connector and optical fiber transmitting connector, including a seat body, an eSATA connector, an optical fiber transmitting connector, a sealing lid and an outer casing. The seat body is arranged a first slot, under which a second slot is arranged. At back of the seat body, there is a recessing part, at upper portion of which an assembling opening communicated to the first slot is arranged. A plurality of slots are arranged on a wall surface of the recessing part. The eSATA connector is assembled in the first slot, while the optical fiber transmitting connector is assembled in the second slot. The sealing lid is assembled to the recessing part at back of the seat body. A protruding portion arranged at the sealing lid is assembled to the assembling opening of the recessing part. On a wall surface of the sealing lid, there are a plurality of striping ribs snapped into the slots. The outer casing externally fitted to the seat body is arranged a first perforation and a second perforation at a front side face thereof and respectively corresponding to the first slot and the second slot. In addition, a set of fixedly connecting legs are extended from a side face at a bottom part of the outer casing.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a perspective illustration of the outer appearance of a motherboard according to the prior arts;

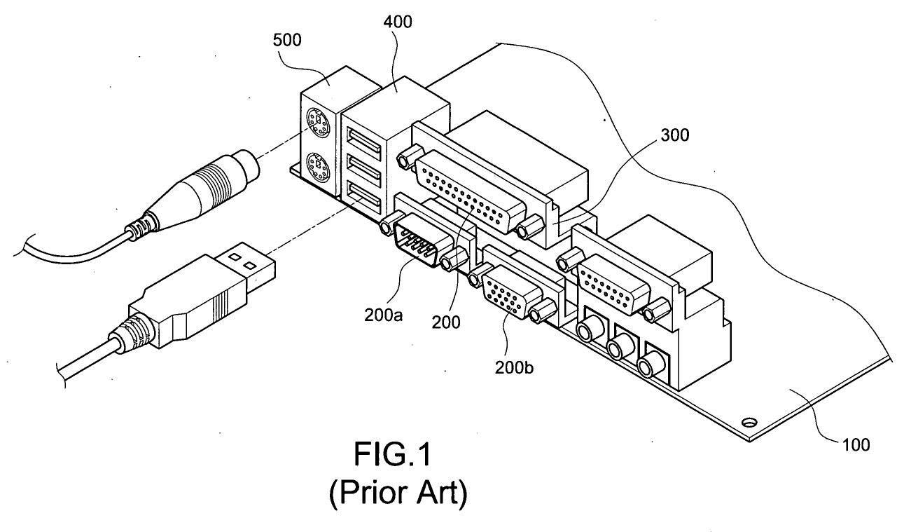

FIG. 2 is a perspective illustration of the outer appearance of a multi-port connector having eSATA connector and optical fiber transmitting connector according to the present invention;

FIG. 3 is an explosive illustration of a multi-port connector having eSATA connector and optical fiber transmitting connector according to the present invention;

FIG. 4 is an explosive illustration of FIG. 3 viewed from another angle; and

FIG. 5 is a using status illustration of the multi-port connector according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

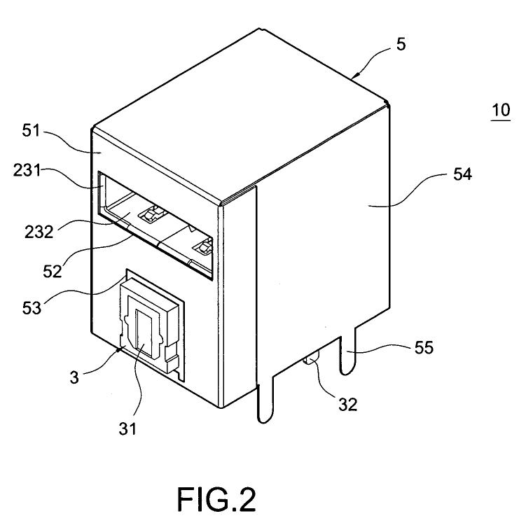

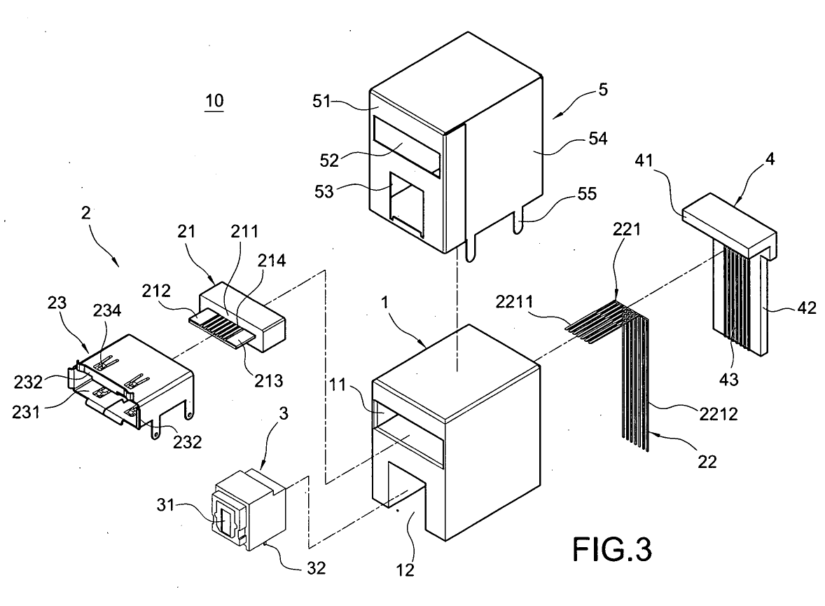

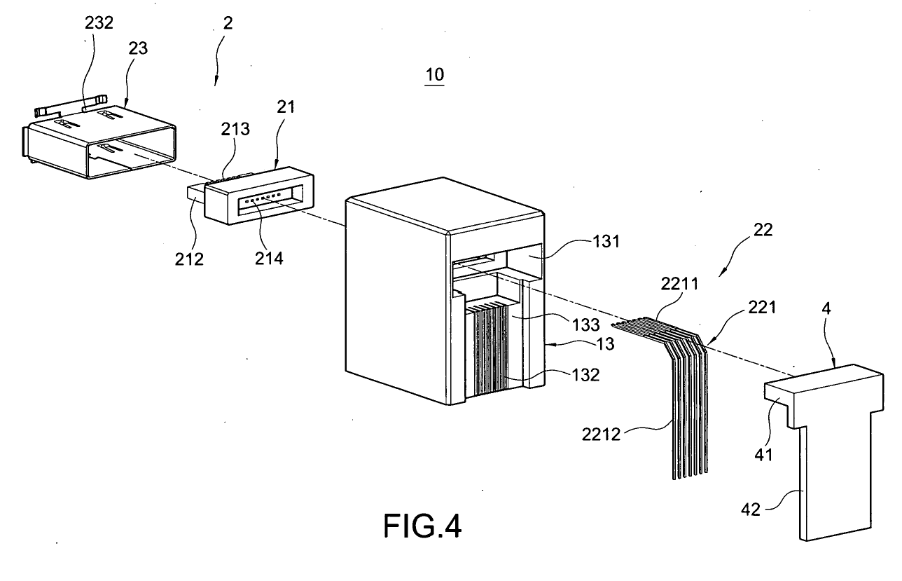

Please refer to FIG. 2 and FIG. 3, which respectively are a perspective and explosive illustrations of a multi-port connector having eSATA connector and optical fiber transmitting connector according to the present invention, and also refer to FIG. 4, which is an explosive illustration of FIG. 3 viewed from another angle. As shown in these figures, a multi-port connector 10 having eSATA connector and optical fiber transmitting connector according to the present invention includes a seat body 1, an eSATA connector 2, an optical fiber transmitting connector 3, a sealing lid 4 and an outer casing 5.

In this preferable embodiment, the seat body 1 is made of an electrically insulating material, on which a first slot 11 for assembling and connecting the eSATA connector 2 is arranged. Under the first slot 11, there is a second slot 12, by which an optical fiber transmitting connector 3 is arranged. At back of the seat body 1, a “T”-shaped recessing part 13 is arranged, at upper portion of which there is an assembling opening 131 communicated to the first slot 11. Meanwhile, a plurality of slots 133 are arranged on a wall surface 132 of the recessing part 13.

In this case, the eSATA connector 2 assembled to the first slot 11 consists of an insulating supporting body 21, a terminal set 22 and a metallic shell 23. At front side of the insulating supporting body 21, a sealing wall 211 is arranged, toward outward direction of which a supporting piece 212 is extended. At rear side of the supporting piece 212, a plurality of grooves 213 are arranged. At the grooves 213, a plurality of perforations 214 arranged correspond to the sealing wall 211 for providing the terminal set 22 to pass through. The terminal set 22 is composed of a plurality of connecting legs 221, on each of which a front connecting leg 2211 is arranged, at rear side of which a rear connecting leg 2212 bent into 90 degrees is extended. After the front connecting leg 2211 passes through the perforation 214 and is fixedly inserted into the groove 213, the rear connecting leg 2212 is embedded into the slot 133 of the seat body 1. At front side of the metallic shell 23, there is a plug-in opening 231, at the circumference of which a plurality of stopping pieces 232 are supportively connected, which are abutted against the opening circumference of the first slot 11 of the seat body 1. In addition, a plurality of leaf springs 234 are arranged on the surface of the metallic shell 23. After the plug of the eSATA transmitting line (not shown in the figure) is plugged in the plug-in opening 232, the plug of the eSATA transmitting line is tightly clipped by the plural leaf springs 234 for transmitting data.

Furthermore, the optical fiber transmitting connector 3 assembled into the second slot 12 of the seat body 1 has an inserting opening 31 at a front thereof for providing the plug of an optical fiber patch cord (not shown in the figure) to plug in for an optical transmission. In addition, a connecting leg 32 is arranged at a bottom of the optical fiber transmitting connector 3 for providing an electrical connection to the motherboard (not shown in the figure).

In this preferable embodiment, with a protruding portion 41 arranged thereon, the sealing lid 4 is assembled and connected at back of the seat body 1. When the sealing lid 4 has been assembled and connected into the assembling opening 131 of the recessing part 13 at back of the seat body 1, a plurality of striping ribs 43 arranged on a wall surface 42 of the sealing lid 4 are embedded into the slots 133, making the striping ribs 43 abutted against the rear connecting legs 2212 of the terminal set 22 to avoid the rear connecting legs 2212 from loosely moving.

In this case, the outer casing 5 made of metallic materials is fitted externally to the seat body 1 by arranging a first perforation 52 and a second perforation 53 at a front side thereof for providing the plugs of eSATA connector and optical fiber patch cord to pass through. A set of connecting legs 55 extended at bottom of a side face 54 of the outer casing 5 are fixedly connected to a motherboard. When the plugs of eSATA connector and optical fiber patch cord are being pulled out or plugged in, it won't create a shaking phenomenon to the multi-port connector, so it is very easy for a user to pull out or plug in a plug of eSATA connector or optical fiber patch cord.

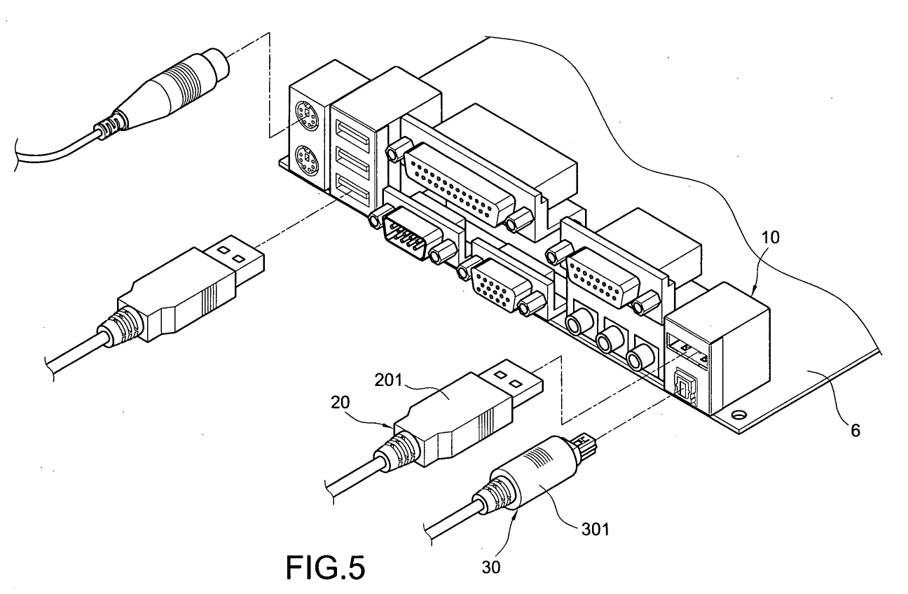

Please refer to FIG. 5, which is a using status illustration of the multi-port connector according to the present invention. As shown in this figure, after the multi-port connector 10 is electrically connected to a circuit board 6, the multi-port connector 10 is fixedly arranged to the circuit board 6. When a user needs to download data, he only has to plug the plug 201 of the eSATA transmitting line 20 into the plug-in opening 231 of the multi-port connector 10, making the plug 201 electrically connected to the eSATA connector 2, thereby data stored in an external disk being able to be uploaded to the computer or the data in the computer being able to be downloaded to the external disk, vice versa.

After the plug 301 of an optical fiber patch cord 30 is plugged into the inserting opening 31 of the optical fiber transmitting connector 3, making the plug 301 of the optical fiber patch cord 30 electrically connected to the optical fiber transmitting connector 3 for processing a light transmission, digital signal from external player (not shown in the figure) can be transmitted to computer or to decoder.

According to the aforementioned structure, a multi-port connector having eSATA connector and optical fiber transmitting connector of the present invention is thereby obtained.

Summarizing aforementioned description, the invention is an indispensable product of novelty indeed, which may positively reach the expected usage objective for solving the drawbacks of the prior arts, and which extremely possesses the innovation and progressiveness for completely fulfilling the applying merits of new type patent, according to which the invention is thereby applied. Please examine the application carefully and grant it as a formal patent for protecting the rights of the inventor.

However, the aforementioned description is only a preferable embodiment according to the present invention, being not used to limit the patent scope of the invention, so equivalently structural variation made to the contents of the present invention, for example, description and drawings, is all covered by the claims claimed thereinafter.

What is claimed is:

1. A multi-port connector having eSATA connector and optical fiber transmitting connector, including:
a seat body, at an upper portion of which a first slot is arranged, under which there is a second slot;
an eSATA connector, for being assembled into the first slot; and
an optical fiber transmitting connector, for being assembled into the second slot.

2. The multi-port connector according to claim 1, wherein the seat body is made of an insulating material.

3. The multi-port connector according to claim 1, wherein a recessing part is arranged at a back of the seat body, an upper portion of the recessing part having an assembling opening communicated to the first slot, and a plurality of slots being arranged on a wall surface of the recessing part.

4. The multi-port connector according to claim 3, wherein the recessing part is configured as a “T” shape.

5. The multi-port connector according to claim 1, wherein the eSATA connector is comprised of an insulating supporting body, a terminal set and a metallic shell.

6. The multi-port connector according to claim 5, wherein a front side of the insulating supporting body is arranged a sealing wall, which is extended outwardly a supporting piece, on which a plurality of grooves are arranged, on the grooves corresponding to the sealing wall, a plurality of perforations being arranged.

7. The multi-port connector according to claim 5, wherein the terminal set is comprised of a plurality of connecting legs, at each of which a front connecting leg is arranged, at a rear side of which a rear connecting let bent into 90 degrees is arranged.

8. The multi-port connector according to claim 5, wherein a plug-in opening is arranged at a front of the metallic shell, and wherein a plurality of arc stopping pieces are supportively connected at a circumference of the plug-in opening and abutted against a circumference of the first slot of the seat body.

9. The multi-port connector according to claim 1, wherein the optical fiber transmitting interface connector is assembled in the second slot of the seat body, and wherein the optical fiber transmitting interface connector is arranged an inserting opening at a front side thereof and a connecting leg at a bottom part thereof.

10. The multi-port connector according to claim 1, further including a sealing lid assembled in the recessing part at a back of the seat body, a protruding portion arranged at the sealing lid and a plurality of striping ribs arranged on a wall surface of the sealing lid.

11. The multi-port connector according to claim 1, further including an outer casing externally fitted to the seat, a first perforation and a second perforation arranged at a front side of the outer casing and a set of connecting legs extended at a bottom part of a side face of the outer casing.

12. The multi-port connector according to claim 11, wherein the outer casing is made of a metallic material.
